(19) United States
(12) Patent Application Publication
(10) Pub. No.: US 2012/0055585 A1
(43) Pub. Date: Mar. 8, 2012

(54) Hydraulic wood splitter

(76) Inventor: Timothy M. Gassner, Redmond, OR (US)

(21) Appl. No.: 12/807,258

(22) Filed: Sep. 2, 2010

(51) Int. Cl. B27L 7/06

(52) U.S. Cl. 144/195.1

(57) ABSTRACT

An apparatus for splitting logs, or other suitable materials, the apparatus comprising: a frame; a wedge affixed to the forward end of the frame; and means for hands-free control of a hydraulic ram affixed to the aft end of the frame whereby forward movement of the ram splits logs.

### CROSS REFERENCE TO RELATED APPLICATION

a. Provisional Application

### BACKGROUND OF THE INVENTION

a. Field of the Invention

The invention relates to an apparatus for splitting logs or other materials. Splitting logs are typically for the purpose of sizing the logs for burning in a fireplace or wood stove or similar for home ambiance and/or as a heat source. More particularly the invention relates to a hands-free hydraulically operated apparatus capable of splitting logs.

b. Description of the Prior Art

The use of split logs for a source of light and heat is ancient in human history and likely dates backs to soon after man learned how to create and harness fire itself.

Presently many still cut timber in forests and store it, possibly to dry it, so it is available when needed for use or sale. Typically after a tree is felled the trunk and possibly large branches are cut into cylindrical lengths according to the size of the fire box in a stove or fireplace in which it will be used—or an approximation of the fire box size. At some point prior to use the cylindrical log is preferably split lengthwise, perhaps more than once, to create logs which are wedged-shaped in their longitudinal cross section and which are preferred for burning, especially when a fire is brought up to optimal temperature.

The prior art is replete with mechanical devices to split logs into said wedged-shaped sections including sledgehammers and hydraulic splitters well known in the art. Thousands of hydraulic splitters are sold in the United States annually, however, to the subject inventor's knowledge the prior art does not include a hands-free means for splitting wood with a motorized hydraulic splitter. It is important the hydraulics of a wood splitter operate relatively slowly to avoid injury to an operator thereof This is also the nature of many simply-designed hydraulic mechanisms. This is particularly important when a ram common to many hydraulic wood splitter is moving in a forward direction and the log is engaged with a wedge to split the wood. The forward direction of a ram, which forces the log into the wedge, or wherein the ram includes the wedge and forces the log into a substantially fixed object, is initiated by the operator manually controlling a hydraulic actuating lever. The actuating lever controls the hydraulics, typically by controlling a valve which controls the pressure and flow of hydraulic fluid in the system. The actuating lever typically has three positions: forward; backward or reverse; and neutral. The three positions relate to the movement of the ram which typically is connected to a shaft or rod which is connected to a piston within a cylindrical hydraulic barrel. The operator places a log to be split into a position wherein it is between the ram and the wedge; preferably the log abuts the wedge. Then the operator moves the lever into a forward position with his hand which initiates forward movement of the hydraulic ram, which forces the log into the wedge thereby converting linear force to lateral force and splitting the log roughly in half, depending upon the position of the log vis-à-vis the wedge. For reasons including safety, most such devices require the operator to hold the actuating lever in the forward position. Once the log is split the operator, with his hand, releases the lever from the forward position and moves the lever to the reverse position, typically holding the lever in the reverse position until the ram is a sufficient distance from the wedge to fit a new log, or one part of the just split log if smaller wedged-shaped logs are desired, into position to be split. At that time the operator moves the lever to a neutral position. Contrary to the forward and reverse positions the lever does not have to be held to maintain the neutral position of the lever or the piston. Then, with the lever in the neutral position, the operator leaves the actuating lever and places the next log into place for splitting and perhaps stacks the just split log. And the cycle is repeated.

The prior art processes with which the inventor is familiar are not efficient. The operator is stuck at the actuating lever during forward movement of the ram and reverse movement of the ram. Accordingly the operator may not be able to do anything else. The operator cannot: manipulate the log or logs with his hands during splitting; pick up split logs on the ground; stack split logs; and/or positioning a new log for splitting. While the operator cannot leave the foot pedal, which maintain forward movement of the ram, the operator is much more productive if he can work during the forward and reverse movement of the ram.

It is also desirable to be able to automatically control when the hydraulic controls switch from reverse to neutral, which may keep the operator from having to return to the actuating lever, to move it to neutral, if the actuating lever can be left in the reverse position without the operator holding it in the reverse position. What is therefore needed is a hands-free hydraulic wood splitting device which can split logs of varying lengths; wherein the hands-free feature is realized during forward operation; wherein the hands-free and the foot-free feature is realized during reverse operation; wherein the device automatically, that is without operator intervention, changes the device from reverse operation to neutral operation; and wherein, and as is the case with the prior art, hands-free and foot-free operation is realized during the neutral operation.

c. An Object of the Invention

It is therefore an object of the present invention to provide a safe hands-free log splitting device which can also accommodate various length logs

### SUMMARY OF THE INVENTION

An apparatus for splitting logs, or other suitable materials, the apparatus comprising: a frame; a wedge affixed to the forward end of the frame; and means for hands-free control of a hydraulic ram affixed to the aft end of the frame whereby forward movement of the ram splits logs.

A method for splitting logs, or other suitable materials, comprises the steps of providing an apparatus for supporting logs, or other suitable materials, the apparatus including a frame for supporting the suitable material thereon, a wedge affixed to the forward end of the frame, a hydraulic ram and means for hands-free control of the hydraulic ram which moves in respect to the wedge; positioning the suitable material to be split substantially adjacent to the wedge; hands-free setting of said means for control of the hydraulic ram to a forward position thereby moving the ram and thereby moving the suitable material into contact with the wedge, whereby the suitable material is forced into the wedge causing the suitable material to split; hands-free setting of said means for control of the hydraulic ram to a reverse position until the ram is a predetermined distance from the wedge wherein a stop provides hands-free setting of said means for control of the hydraulic ram to a neutral position.

### BRIEF DESCRIPTION OF THE DRAWING

FIG. 1 is a perspective view of an embodiment of an embodiment of the subject invention.

### DETAILED DESCRIPTION OF THE INVENTION AND ITS PREFERRED EMBODIMENTS

Various other objects features and advantages of the invention will become more apparent by reading the following detailed description in conjunction with the drawing depicting a single embodiment of the invention for example only.

A frame 50 serves as the platform for the invention components as well as the surface on which a hydraulic ram 41 travels and suitable material is split. The frame 50 preferably includes a lengthwise flat surface, such as the top of an I-beam and/or table-top-like surface. Regardless, the invention merely requires a structurally sound and stable platform for the components described generally and specially herein. Such a platform will bear the weight and the in-use forces exerted thereon as well as providing a surface for relatively unencumbered movement of the ram 41 or functional equivalent thereof. In an embodiment of the invention frame 50 includes an I-beam which provides the necessary structural integrity and a smooth surface for the ram 41 as well as related components described herein. Any platform design that functions in a substantially equivalent way with substantially equivalent results as the I-beam and platform disclosed herein and depicted in the drawing is anticipated by the subject invention.

A wedge 44 affixed to frame 50 merely provides a means for converting linear energy, which is preferably the linear movement of the hydraulic ram 41, to lateral energy, which in one embodiment of the invention results in the splitting of a properly positioned log (not shown). The hydraulic ram 41 is moved by hydraulics for the generation, control and transmission of power by use of pressurized liquids: theories and concepts which are well-known in the art.

An embodiment of the invention utilizes a closed hydraulic system (shown in part) which directs pressurized liquid or fluid into a cylinder 43 on either side of a piston (not shown) housed by cylinder 43 in order to move said piston. A reservoir or well (not shown) provides fluid to the system. A pump (not shown) intermediate to the reservoir and a valve control 40 provides pressure to the system. When pressurized fluid is directed to one side of the piston residing within cylinder 43 through a forward feed hose 84, the piston is moved in one direction, in this case forward, while non-pressurized fluid on the other side of the piston is returned to a hydraulic reservoir in this case through a reverse return hose 81. The piston is preferably connected to a shaft 42 connecting the piston to ram 41. Driving the piston in a forward direction preferably drives ram 41 toward wedge 44, which ultimately splits the wood.

Foot pedal 11 initiates forward movement of ram 41. Because the operator is controlling ram 41 forward movement with his foot this operation is hands-free. Preferably foot control 1 is proximate to wedge 44 which allows the operator to use her hands to properly position the log prior to splitting, or grab or catch the pieces of the just-split log, if it is safe to do so, during and/or after the splitting process. Alternatively foot control 11 may not be proximate to the wedge placing the operator out-of-reach of the wedge for safety reasons, nevertheless, advantages of hands-free operation may be realized by the operator. When pressure is released from foot control 11 the lever system disclosed herein switches valve control 40 to a reverse function and pressurized fluid is directed to the other side of the piston residing in cylinder 43 through a reverse feed hose 83, and the piston is moved in a reverse direction and ram 41 is moved away from wedge 44, while non-pressurized fluid on the other side of the piston is returned to the hydraulic reservoir through a forward return hose 82. When ram 41 is a sufficient distance away from wedge 44, which may be predetermined by the operator in accordance with the size of the material to be split, pressure is automatically equalized on each side of the piston thereby ceasing movement of ram 41. This is a neutral position. It should be appreciated that alternative mechanical means of moving a ram that are substantially functionally equivalent are anticipated by the subject invention.

A stop 70 may mechanically move a hydraulic actuating lever 30 to a neutral position. The actuating lever 30 is also controlled by foot control 11 through a series of springs, levers and pivot points wherein pushing foot control 11 moves lever 30 to a forward position which moves ram 41 in a forward direction and release of foot control 11 moves ram 41 in a reverse direction until ram 41 reaches a predetermined position and lever 30 is automatically moved to a neutral position.

Tab 66 in conjunctions with stop 70 and connecting rod 63 through a series of springs, levers and pivot points wherein when ram 41 reaches a certain distance from wedge 44 lever 30 is moved to a neutral position.

Varying the length of stop 70 changes the ram 41 location at which lever 30 is moved to the neutral position, so the operator may install a different length stop according to the length of log or logs to be split. Stop 70 is removably affixed to ram 41 by any of number of means known in the art. Additionally stop 70 may be slidably secured to frame 50 with U bracket 72 which is affixed to frame 50. Alternative means of securing stop 70 to frame 50 are well known in the art.

Alternatively, ram 41may float on frame 50, with more than one U bracket 72 (not shown) and when ram 41 hits the proximal end of stop 70, nearest wedge 44, the distal end of stop 70 hits spring loaded tab 66 and lever 30 is moved to neutral. Accordingly, calibrated varying lengths of a stop 70 maybe used according to the size of the material to be split. Stop 70 merely functions as a position sensor wherein at a certain position of ram 41 the (hydraulic) system is switched to a neutral state. Alternative means for determining the position of the ram are well known in the art including laser measuring devices and charged couple devices that sense movement and/or position by detecting changes in electromagnetic energy. Other electronic controls known in the art are equally applicable. These technologies may be coupled to the hands-free log splitting apparatus such that when the ram position is determined to be a sufficient distance from the wedge to allow another log to be positioned for splitting, the pressure on each side of the hydraulic piston are equalized and the ram movement is ceased. Other drive means are known in the art which would preferably permit hands-free operation of a log splitter that is limited to forward ram movement control; automatic forward-to-reverse control when forward is pro-actively released and ram position based shifting from reverse to neutral. These technologies and similar functional equivalents thereof may be incorporated to achieve the same results and are anticipated by the subject invention.

For safety purposes, the operator may manually move the hydraulic controls to neutral prior to the automatic shift to neutral described above. Alternative means of manual neutral positioning of lever 30 are known in the art but a simple mechanical method, not shown, includes a removable cotter pin, or “R” clip which may be fitted into bored holes (not shown) in stop 70 in conjunction with U bracket 72 wherein spring loaded tab 66 may be kept in a neutral position vis-à-vis lever 30 regardless of the position of ram 41. Only a force sufficient to shift lever 30 to neutral is necessary and any of an assorted mechanical means to maintain said position at myriad places in the spring, lever and pivoted system described herein.

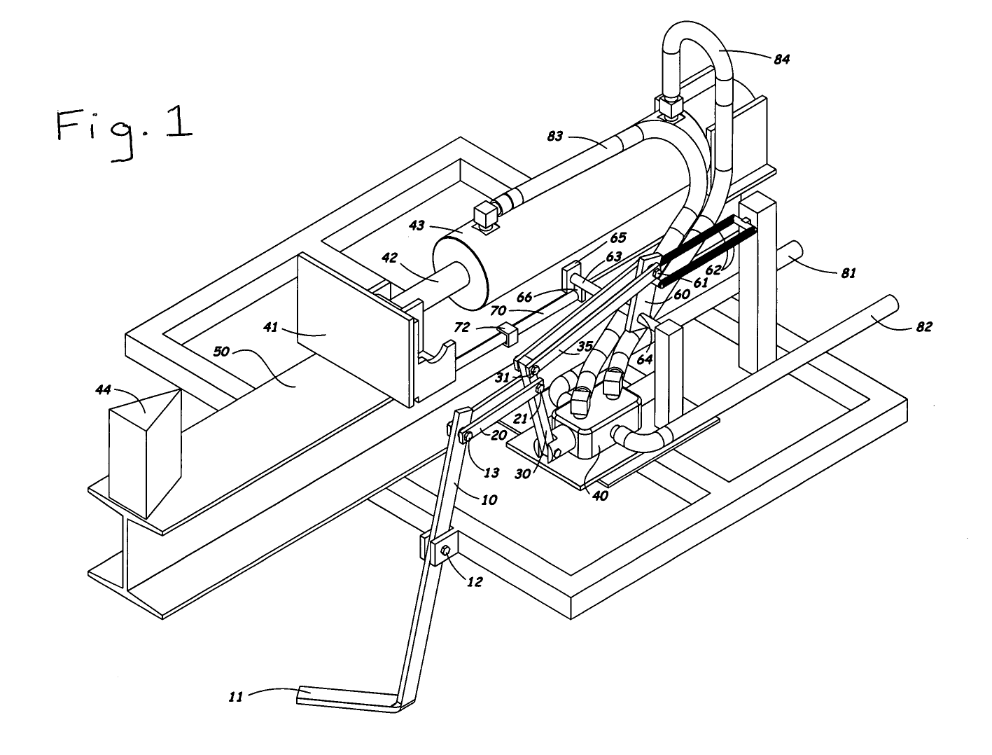

It may also be desirable to retrofit existing hand-control hydraulic splitting mechanisms with elements of the subject invention to render a hands-free system. With the concept disclosed herein, the art is replete with technologies and know-how which will enable one skilled in the art to retrofit accordingly. The embodiment of the invention shown in FIG. 1 is a retrofit wherein the actuating lever for the hydraulic controls was retrofitted with elements of the subject invention.

In the preferred embodiment of the subject invention stop 70 mechanically moves the actuating lever 30 to a neutral position by rotatably linking stop 70 to actuating lever 30 such that when the ram 41 hits floating stop 70, stop 70 moves actuating lever 30 to a neutral position. Alternatively, if proximal end of stop 70 is connected to ram 41 its position is always dictated by the position of ram 41. If stop 41 is shortened ram 41 will move actuating lever 30 when ram 41 is further away from wedge 44.

As depicted in FIG. 1 tab 66 is fixed to connecting rod 63 such that when stop 70 is moved away from wedge 44 by ram 41 the proximal end of stop 70 hits tab 66 which is rotatably mounted to mount 65 and fixed to connecting rod 63 which is in turn connected indirectly to level 30. FIG. 1 represents a retrofitted system. Alternatively, stop 70 could be directly affixed to a mechanism that controls the position of a ram. It is nevertheless preferred that in a mechanical control system stop 70 is adjustable, as in a telescope design wherein varying lengths may be set by the operator, or removable wherein stops of variable length may replace each other.

As depicted in FIG. 1, the need for system calibration, whether retrofitting an existing hydraulic splitter or a manufactured hands-free splitter, cannot be over-stressed. The system must be calibrated such that the change in the actuating lever position caused by the stop is only sufficient to move the lever to a neutral position. This will primarily be a function of the distance between FIG. 1 system connections, spring strengths, lever lengths and the relative position of axes of rotation.

Alternatively, stop 70 may also be adjustable if for example it is constructed of flat bar. Stop 70 may have a number of holes therein wherein a connecting pin (not shown) adjusts the functional length of stop 70 by connecting to either, but preferably not both, ram 41 and tab 66. Multiple holes in stop 70 with a properly calibrated mechanical system to properly control actuating lever 30 may, for example, stop ram 41 from 12 inches to 30 inches from wedge 44 in 3 inch increments. Notwithstanding, any increments may be realized based upon the length of the stop and the calibration of the system. Alternative means of changing the functional length of the stop are well known in the art including utilization of a simple set screw and an aperture in tab 66 (not shown).

A preferred embodiment of the subject invention process follows for a retro-fitted system which has to adapt to an existing hydraulic wood splitter with manual controls for forward, reverse and neutral. An operator (not shown) places a log (not shown) between ram 41 and wedge 44. The operator depresses foot pedal 11. Foot pedal 11 and its connection to frame 50 are of a robust and rigid design such that foot pedal 11 may bear the weight of the operator who depresses or moves pedal 11 to initiate forward movement of ram 41. It is important that pedal 11 and frame 50 can support the loads the operator puts on the system, thereby by allowing the operator to balance himself on both feet while pedal 11 is engaged or depressed and ram 41 is moving forward. Once the log is sufficiently split the operator releases foot pedal 11. If safe, the operator may manipulate the log to be split while pedal 11 is depressed. If safe the operator may manipulate the log to be split during the spitting process while pedal 11 is depressed, which may include catching one or both pieces of the just split log. The operator may continue to be productive after the log is split, when pedal 11 is released and ram 41 is automatically moving in reverse. Depending upon the speed of the hydraulics and the necessary travel distance of ram 41, the operator may pick up and/or stack the pieces of the just split log and/or place another log in position to be split while the ram is moving in a reverse direction. The operator does not have to remain at hydraulic actuating lever 30, or in the case of the subject invention, at foot pedal 11 when the ram is in reverse or neutral.

A prototype of the subject invention has been built by the inventor. Referring now to the details of the invention in FIG. 1a detailed description of the prototype follows.

Foot lever 10: has a foot pedal 11 at one end; is rotatably connected to frame 50 intermediately at foot lever hinge point 12; and is rotatably connected to forward lever 20 at foot lever connection 13. Lever 20 is rotatably connected at connection 13 at one of its ends and is rotatably connected at its opposite end to actuating lever 30 at forward lever connection 21. Actuating lever 30 has three positions: forward; reverse; and neutral (not shown). Actuating lever 30 controls hydraulic valve 40. Hydraulic valve 40 controls the position of hydraulic ram 41. Actuating lever 30 is also rotatably connected to reverse lever 35 at actuating lever connection 31. Reverse lever 35 is rotatably connected to spring lever 60 at spring lever connection 61. Spring lever 60 is rotatably connected to frame 50 but is fixed to connecting rod 63 at junction 64 but connecting rod 63 is rotatably secured to frame 50 at its ends in FIG. 1. Spring lever 60 is also connected to a biasing means, preferably rotatably connected to spring 62 (connection point not numbered but depicted in FIG. 1). The opposite end of spring 62 is preferably rotatably connected to the frame 50 (in FIG. 1 to a post shown but not numbered which is fixed to frame 50). Preferably spring lever 60 is fixed to connecting rod 63 wherein the rotation of connecting rod 63 rotates spring lever 60 which in turn moves actuating lever 30. Spring lever 60 and connecting rod 63 are fixed to each other but rotatably connected, directly or indirectly, to frame 50. Connecting rod 63 is rotatably connected to frame 50 at mount 65 at one end and un-numbered post at its other end. Stop 70 is supported by frame 50 at U bracket 72 and positioned to be in contact with ram 41 and connecting rod 63 during operation of the system. Connecting rod 63 may include a tab 66 or functional equivalent thereof. When the ram 41 moves in a reverse direction it eventually hits stop 70 if it is free floating or removably affixed to ram 41 which moves stop 70 away from wedge 44. The other end of stop 70 engages tab 66 which rotates connecting rod 63 which in turn moves actuating lever 30 from a reverse to a neutral position.

It should be noted that spring 62 maintains a reverse position of lever 30 until a predetermined neutral position is reached by the reversing ram 41, and is biased to a reverse position when held in neutral and engaged to a forward position by foot pedal 11 and lever 10.

If stop 70 is not connected or fixed to connecting rod 63, directly or indirectly, it is critical the system is calibrated such that the speed of the ram 41 in reverse moves tab 66 such that actuating lever 30 is moved to the neutral position without moving stop 70 out of position, so the ram 41 is neutralized and when foot pedal 11 is moved, or depressed, tab 64 moves stop 70 back to a position such that upon the return of ram 41 it will move actuating lever 30 to neutral. Such calibration of the system is critical and easily determined by one-skilled in the art without undue experimentation or independent invention.

The stop 70 maybe fixed to tab 66 and various means known in the art may be utilized to adjust the length of the stop 70 including an adjusting telescoping mechanism with a ratchet mechanism to fix the stop 70 at each incremental length. Alternatively the stop 70 is not fixed to tab 64 but may be adjusted according to means for adjusting where along the stop 70 it is affixed to tab 64 which may include a connecting pin (not shown), with a cotter pin in an orthogonal shaft drilled in the connecting pin so the stop 70 maybe variably removably connected to tab 64 according to drilled holes in stop 70 which may be steel flat bar or functional equivalents thereof Alternative stop 70 may be a flat bar with a longitudinal channel therein allowing for analog, versus digital or fixed increments determined by holes in stop 70, adjustment in conjunction with means for fixing the channeled stop (not shown) to tab 64.

As described herein, alternatively stop 70 may be releasable connected to said tab, or in other ways, to connecting rod 63. Alternative means of correlating the position of ram 41 with the movement of actuating lever 30 from reverse to neutral are well known in the art as well.

Hydraulic systems are well known in the art. In FIG. 1 the hydraulic system includes hydraulic cylinder 43 and hydraulic connecting rod 42 and the piston is not shown. Ram 41 is ultimately controlled by mechanics internal to hydraulic valve controls 40.

Hinge points are directly or indirectly connected to the frame which is fixed or stationary as the whole system may be mobile if frame 50 is mounted to a wheeled transport system such as a trailer; or frame 50 may be mounted on an axle and wheel system directly to facilitate movement of the entire device.

The hydraulic engineering necessary for the proper function of the subject invention are well-known in the art and the function thereof, as depicted in FIG. 1, is self-evident to those skilled in the art.

While specific embodiments from the invention have been described in detail, it would be appreciated by those skilled in the art that there is modification and alterations would be developed in light of the overall teachings of the disclosure. For example, a cable/spring system or a purely electronic control system wherein hands-free actuation moves the hydraulic control from a neutral position to a forward position and when the hands-free actuation is released hydraulic controls are moved from the forward position to a reverse position and wherein a ram position sensor moves the hydraulic controls back to the neutral position. Accordingly, the particular arrangements disclosed are meant to be illustrative only and not limiting as to the scope of the invention which is if you gave them the full breadth of the included claims and any and all equivalents thereof.

I claim:

1. An apparatus for hands-free log splitting, the apparatus comprising:
a frame;
a wedge affixed to a forward portion of the frame;
a hydraulic ram affixed to an aft portion of the frame;
a foot pedal connected to means for controlling the hydraulic ram wherein downward pressure on the foot pedal causes the hydraulic ram to be moved toward the wedge whereby a log supported on the frame between the wedge and the ram is split and wherein release of the foot pedal causes the ram to be moved away from the wedge; and
a stop supported by the frame such that when the ram reaches a predetermined distance from the wedge the ram moves the stop such that the means for controlling the hydraulic ram ceases ram movement.

2. The apparatus as recited in claim 1, wherein the frame includes an I-beam.

3. The apparatus as recited in claim 1, wherein the means for controlling the hydraulic ram includes an actuating lever.

4. The apparatus as recited in claim 3, wherein the actuating lever is biased to a position which causes the ram to be moved away from the wedge.

5. The apparatus as recited in claim 4, wherein means for biasing the actuating lever is a spring.

6. The apparatus as recited in claim 3, wherein the actuating lever controls a hydraulic valve.

7. The apparatus as recited in claim 6, wherein the actuating lever has three positions wherein one position moves the ram forward, one position moves the ram in reverse and one position renders the ram stationary.

8. The apparatus as recited in claim 1, wherein the foot pedal is rotatably connected to the frame.

9. The apparatus as recited in claim 8, wherein the pedal is biased by a spring in a position which causes the ram to be moved away from the wedge.

10. The apparatus as recited in claim 9, wherein means for controlling the hydraulic ram includes an actuating lever.

11. An apparatus for hands-free control of a ram, the apparatus comprising:
a frame;
a ram stop affixed to a forward portion of the frame;
a ram affixed to an aft portion of the frame;
a foot pedal connected to means for controlling the ram wherein pressure on the foot pedal causes the ram to moved in a direction toward said ram stop whereby an object intermediate to said ram stop and said ram is engaged and wherein when pressure on said foot pedal is released causes the ram to be moved in a direction away from the ram stop; and
wherein means for determining the ram position communicates to means for controlling the ram movement a switch to neutral when the ram reaches a predetermined position.

12. A method comprising: (a) receiving a first foot controlled signal to move a ram on a frame in a first direction; (b) transferring forward energy of said ram to lateral energy; (c) receiving a second foot controlled signal to move said ram in a direction substantially opposite to said first direction; (c) receiving a ram position signal to cease movement of said ram.
